(19) United States
(12) Patent Application Publication
(10) Pub. No.: US 2009/0185205 A1
(43) Pub. Date: Jul. 23, 2009

(54) Image processing apparatus, image processing method, and computer program product

(75) Inventor: Takehiro Nakajima, Tokyo (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/318,561

(22) Filed: Dec. 31, 2008

(30) Foreign Application Priority Data
Jan. 18, 2008 (JP) 2008-009124

(51) Int. Cl. H04N 1/60

(52) U.S. Cl. 358/1.9

(57) ABSTRACT

An image processing apparatus that prints a first color in an image in a second color in a printout includes a first-color setting unit that specifies the first color in an RGB colorimetric system; a second-color setting unit that sets the second color; a color determining unit that determines whether the first color is a chromatic color or an achromatic color; and a color converting unit that, when the color determining unit determines that the first color is a chromatic color, performs color conversion processing of converting the first color into a color that is reproduced with a gradation level having a hue same as the second color and a color saturation lower than the second color.

### CROSS-REFERENCE TO RELATED APPLICATIONS

The present application claims priority to and incorporates by reference the entire contents of Japanese priority document 2008-009124 filed in Japan on Jan. 18, 2008.

### BACKGROUND OF THE INVENTION

1. Field of the Invention

The present invention relates to an image processing apparatus, an image processing method, and a computer program product.

2. Description of the Related Art

In recent years, software such as computer aided design (CAD) applications, word processors, and graphic applications is becoming more advanced because of improved performance of personal computers, and various types of documents, such as CAD drawings and text documents, are produced with these advanced software applications. These produced documents are output as printed matter using, for example, a color printer and are then filed or copied depending on the purpose of the document. Documents produced in this way can undergo so-called “inking”, which is defined as writing, for example, comments elicited in a meeting on a produced document with a pen of a different color from the color of text and line drawings in the document.

Then, printed matter that has undergone the inking can be copied. To copy such printed matter, an image processing apparatus such as a full-color electrophotographic copier is used in many cases. Furthermore, when documents that have undergone the inking are to be copied, it is sometimes preferable that the color tone of the inking be modified to a more noticeable color tone according to the quality of the printing paper to highlight the inking area. It is also desirable not only that the recognizability be improved but also that the consumption of consumables be controlled by providing printed matter where the use of colorant is restricted without decreasing the recognizability of an inking area, in other words, by providing printed matter that has a so-called reduced number of color dimensions.

Ways of improving the recognizability of printed matter that has undergone the inking with a coloring marker or a ballpoint pen have been discussed. For example, Japanese Patent Application Laid-open No. 2004-356853 discloses an image processing apparatus and an image processing method in which not only is it possible to suppress color blurring of two-color printing resulting from a reduced number of used colors, but also it is possible to reduce costs by reducing the number of dimensions of a three-dimensional color signal obtained by the image processing apparatus and then reproducing printed matter in two-dimensional colors specified in the reduction.

Furthermore, Japanese Patent Application Laid-open No. 2005-167679 and Japanese Patent Application Laid-open No. 2005-193442 disclose subtractive color processing using hue-luminance-saturation (HLS) color image data to perform subtractive color adjustment. In addition, Japanese Patent Application Laid-open No. 2005-252993 discloses color conversion from the red-green-blue (RGB) calorimetric system to the cyan-magenta-yellow-black (CMYK) calorimetric system based on a color-conversion table adopted for a specified color component from among a plurality of prepared color-conversion tables. Also, Japanese Patent Application Laid-open No. 2005-328276 discloses a technique for converting an RGB signal into the HLS calorimetric system to perform hue determination; dividing the input color image into an area corresponding to a specified hue range that is painted in a specified basic color and an area corresponding to the remaining range that is painted in gray; and finally outputting the resultant image to a color-image output unit.

In Japanese Patent Application Laid-open No. 2004-356853, to eliminate color blurring between a primary color and a secondary color resulting from reducing the number of dimensions from a three-dimensional color signal to a two-dimensional color signal, a colored image is formed by introducing processing solely used for the secondary color. According to Japanese Patent Application Laid-open No. 2004-356853, not only can the recognizability of a colored portion be enhanced but also the printing cost can be reduced. However, because the processing solely used for the secondary color sacrifices gradation reproducibility, a portion printed in the secondary color inevitably exhibits a visual texture different from that of the surrounding image area. Furthermore, to print the secondary color, a color conversion process for specific-color printing needs to be implemented in the image processing apparatus, in addition to a color conversion process for normal printing.

In short, although the image processing apparatus and the image processing method described in Japanese Patent Application Laid-open No. 2004-356853 can improve the recognizability of a colored portion and, furthermore, can decrease the operating cost, the image processing apparatus needs more memory resources and software resources. This may offset the decrease in operating cost by an increase in the cost needed for the image processing apparatus. In addition, because implementation of the image processing apparatus becomes more complicated, version upgrades and maintenance become more time-consuming.

Furthermore, although Japanese Patent Application Laid-open No. 2005-167679, Japanese Patent Application Laid-open No. 2005-193442, and Japanese Patent Application Laid-open No. 2005-252993 disclose color conversion processing using a plurality of color-conversion tables and subtractive color processing based on a hue range, they do not disclose image processing for specific-color conversion with minimized consumption of hardware resources, such as memory resources, while maintaining the gradation level without significantly modifying the color conversion processing.

### SUMMARY OF THE INVENTION

It is an object of the present invention to at least partially solve the problems in the conventional technology.

According to an aspect of the present invention, there is provided an image processing apparatus that prints a first color in an image in a second color in a printout, the image processing apparatus including a first-color setting unit that specifies the first color in a red-green-blue calorimetric system; a second-color setting unit that sets the second color; a color determining unit that determines whether the first color is a chromatic color or an achromatic color; and a color converting unit that, when the color determining unit determines that the first color is a chromatic color, performs color conversion processing of converting the first color into a color that is reproduced with a gradation level having a hue same as the second color and a color saturation lower than the second color.

According to another aspect of the present invention, there is provided an image processing method executed by an image processing apparatus that prints a first color in an image in a second color in a printout, the image processing method including receiving specification of the first color in a red-green-blue calorimetric system; receiving setting of the second color; determining whether the first color is a chromatic color or an achromatic color; first converting including, when it is determined at the determining that the first color is a chromatic color, converting the first color into a color that is reproduced with a gradation level having a hue same as the second color and a color saturation lower than the second color; and second converting including, when it is determined at the determining that the first color is an achromatic color, converting a luminance level of the achromatic color to reproduce the achromatic color with the gradation level.

According to still another aspect of the present invention, there is provided a computer program product that includes a computer-readable recording medium that stores therein a computer program including computer program codes that when executed cause an image forming apparatus to execute the above image processing method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a printer and an image processing apparatus according to an embodiment of the present invention;

FIGS. 2A, 2B, and 2C are schematic diagrams for explaining specific-color conversion processing performed by the image processing apparatus in response to a user command;

FIG. 3 is a functional block diagram of a second-color-conversion-table generating unit used by the image processing apparatus;

FIG. 4 is a schematic diagram for explaining specific-color conversion processing that uses a second color-conversion table based on a CIE1976L*a*b* calorimetric system that is interchangeable with RGB and CMY systems via transformation;

FIGS. 5A and 5B are graphs for explaining color conversion processing based on a L*a*b* calorimetric system;

FIG. 6 is a flowchart of processing (extraction of RGB data) for generating the second color-conversion table;

FIG. 7 is a flowchart of processing for registering the second color-conversion table that associates calculated R′G′B values with the RGB values of a specific color or a hue range;

FIGS. 8A and 8B are graphs depicting the processing in Step S704 described with reference to FIG. 7;

FIGS. 9A and 9B are graphs depicting the relationship among RGB data, a hue range, and specific-color conversion processing of an image;

FIG. 10 is a flowchart illustrating an image processing method realized by the image processing apparatus; and

FIG. 11 is a schematic diagram of a print dialog that is displayed to a user by the image processing apparatus.

### DETAILED DESCRIPTION OF THE PREFERRED EMBODIMENTS

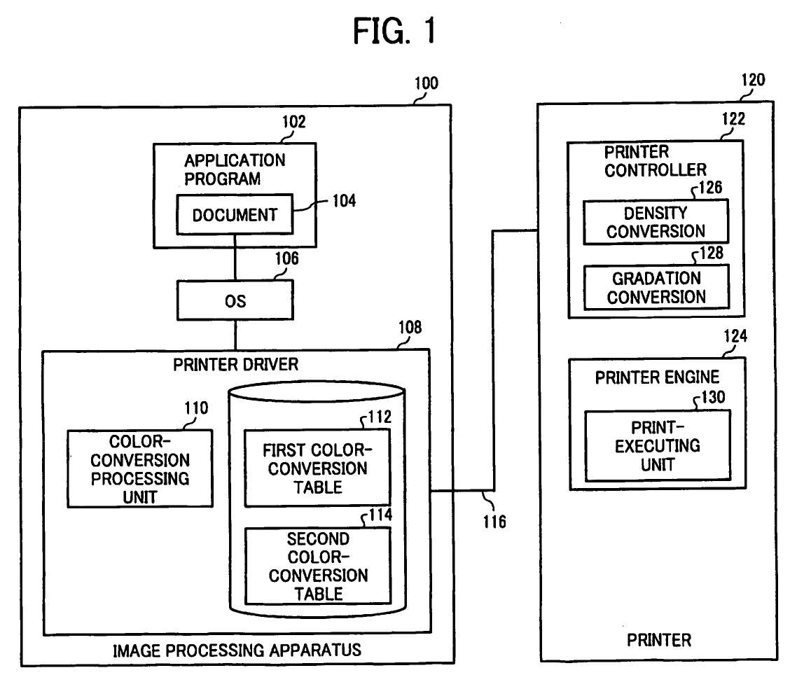

Exemplary embodiments of the present invention are explained in detail below with reference to the accompanying drawings. It should be noted; however, that the present invention is not limited to those embodiments. FIG. 1 is a block diagram of a printer 120 and an image processing apparatus 100 according to an embodiment of the present invention. The image processing apparatus 100 includes an application program 102 that performs image processing, facsimile transmission/reception, mail transmission/reception, and so forth and an operating system (OS) 106 that manages the execution of the application program 102 and manages resources of the image processing apparatus 100. The application program 102 can be, for example, a scanner application, a CAD application, a word processing application, or an image processing application. Alternatively, if the image processing apparatus 100 is an image forming apparatus such as a multi-function peripheral (MFP) including a printer and its peripherals (described later), the application program 102 can be, for example, a printer application, a facsimile application, or a mail application.

The functions of major applications are described below. From a scanner provided with components such as a charge-coupled device (CCD), a scanner application obtains printed matter produced by, for example, a CAD application or a word processor and generates a raster image such as a bitmap (BMP) image. An image processing application converts the raster image generated by the scanner application into a document 104 in an appropriate format, such as graphics interchange format (GIF), BMP, tagged image format (TIFF), or joint photographic experts group (JPEG), and stores it in a recording apparatus such as an hard disk drive (HDD).

If a CAD application or a word processing application is implemented as the application program 102, the document 104 generated by the application program 102 is printed out or stored in an HDD in response to a user's command. The generated printed matter is used and subjected to inking, for example, during a meeting, is converted into an image by another image processing apparatus, and is then filed by, for example, a database application.

When the user wants to print the document 104, the document 104 is sent to a printer driver 108 via the OS 106 according to a print command from the user, and then printing is performed. The printer driver 108 obtains from the OS 106 data for the document 104 described, for example, in the DEVMODE structure. The printer driver 108 manages a color-conversion processing unit 110 and a memory area that stores a plurality of color-conversion tables used by the color-conversion processing unit 110. The printer driver 108 identifies images and character data in the obtained data of the document 104 and converts the images into raster images. Furthermore, the printer driver 108 converts character data into font data and also performs paging processing to produce print data in a format such as the page description language (PDL).

The color-conversion processing unit 110 converts data identified as an image into a raster image, which is then subjected to color conversion processing. Details of color conversion processing will be described later. If the image contains a color (specific color) or a hue range specified by the user, the color-conversion processing unit 110 performs processing for producing raster data in which the specific color is corrected to a target color specified by the user. Furthermore, if the user does not specify specific-color conversion processing, the color-conversion processing unit 110 performs processing for producing a raster image without performing color conversion processing. Color conversion processing is not performed for hues not included in the specific color or hue range even if the user specifies specific-color conversion processing.

To allow the color-conversion processing unit 110 to perform the color conversion processing described above, the printer driver 108 includes a first color-conversion table 112 and a second color-conversion table 114. If specific-color conversion is not performed, the color-conversion processing unit 110 performs high-definition color reproduction using only the first color-conversion table 112 to produce print data. For this purpose, the first color-conversion table 112 performs color conversion from input-dependent RGB color data into output-device-dependent CMY color data. Thereafter, a component corresponding to K (black) is introduced to generate print data in the form of CMYK color data. On the other hand, when it is determined that the user has issued a command for specific-color conversion processing, the color-conversion processing unit 110 modifies the input-dependent RGB color data of the user's specific color or the hue range using the second color-conversion table 114 to produce the output-device dependent target color specified by the user.

Color conversion processing based on the second color-conversion table 114 can be performed directly (1) from input-dependent RGB color data into output-device-dependent CMY color data, just as with the first color-conversion table 112. Alternatively, color conversion processing based on the second color-conversion table 114 can also be performed (2) from input-dependent RGB color data to R′G′B′ color data that provides output-device-dependent CMY color data, considering that the first color-conversion table 112 is already available and the aim is to provide output-device-dependent CMY color data.

If the color conversion processing described in (2) above is performed using the second color-conversion table 114, the present embodiment is suitable for a printer driver of the image processing apparatus 100 in the following points: the need to form a lookup table via the CIE1976L*a*b* uniform color space can be eliminated; specific-color conversion processing based on the second color-conversion table 114 can be performed by effectively using the existing first color-conversion table 112 and a K-component-introduction processing unit; the second color-conversion table 114 can be generated on the fly in response to a user request; and memory resources can be saved.

The first color-conversion table 112 and the second color-conversion table 114 can be stored in a fixed storage device such as an HDD when the printer driver 108 is to be installed so that the tables 112 and 114 can be loaded into a random access memory (RAM) for color conversion processing when image processing is performed or the image processing apparatus 100 is started up. Alternatively, if the image processing apparatus 100 is to generate the second color-conversion table 114 on the fly according to the user's command, only the first color-conversion table 112 can be stored in a storage device such as an HDD, a read only memory (ROM), an erasable and programmable read only memory (EPROM), or an electrically erasable and programmable read only memory (EEPROM) when the printer driver 108 is installed.

The produced print data is sent to the printer 120 via a bus such as a universal serial bus (USB), IEEE1294, or IEEE1392 or a connection line 116 such as a local area network (LAN). The printer 120 includes a printer controller 122 and a printer engine 124. The printer controller 122 subjects the received print data to a density conversion 126 based on gradation bits and to a gradation conversion 128 (area coverage modulation) by applying a dither pattern and then sends the resultant data to the printer engine 124. The printer controller 122 performs density conversion processing for converting RGB data represented with a depth of eight bits for each color into density represented with CMY area coverage modulation and performs area-coverage-modulation conversion processing for selecting a dither pattern corresponding to the relevant area. The printer controller 122 can include a density-conversion table and a dither-pattern table to perform density conversion and gradation conversion.

The printer engine 124 receives the data generated by the printer controller 122 and controls the driving of a print-executing unit 130 that includes a print head and various types of driving motors in the case of a photoreceptive-element, semiconductor-laser, or inkjet-recording method, to output printed matter.

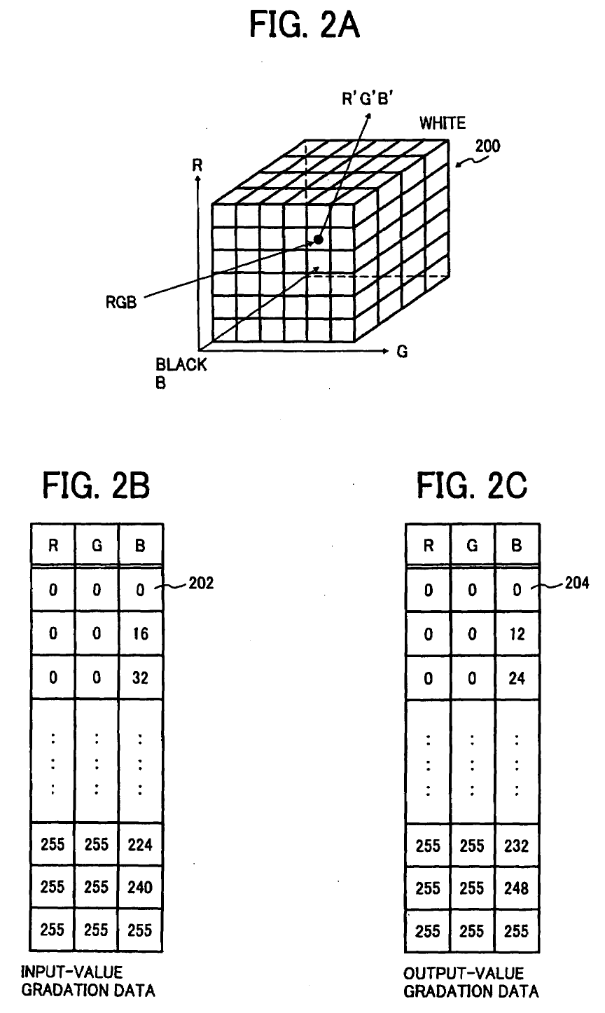

FIGS. 2A, 2B, and 2C are schematic diagrams for explaining specific-color conversion processing performed by the image processing apparatus 100 according to a user command. Input-dependent RGB color data is input to a second color-conversion table 200 of the image processing apparatus 100. The term “input-dependent RGB color data” means color data of the document 104 that is subjected to inking complying with the NTSC standards. Referring to FIG. 2A, the image processing apparatus 100 performs color conversion from input-dependent RGB color data into R′G′B′ color data through the three-dimensional second color-conversion table 200 having representative points at nodes thereof. The R′G′B′ values generated by color conversion are used as input values into the first color-conversion table 112, and print data representing output-device-dependent CMY color data that provides the output-device-dependent target color is generated based on the specific color and the hue range and is then sent to the printer 120.

As shown in FIG. 2A, in the present embodiment, input-dependent RGB color data is converted into R′G′B′ color data for reproducing the input-dependent RGB color data in the target color. FIGS. 2B and 2C are schematic diagrams illustrating R′G′B′ color data generated from input-dependent RGB color data. Referring to FIG. 2C, density gradation is specified also for R′G′B′ color data with gradation levels similar to those of the input-dependent RGB color data. This ensures that gradation reproducibility can be maintained despite color conversion of the specific color or the specified color range.

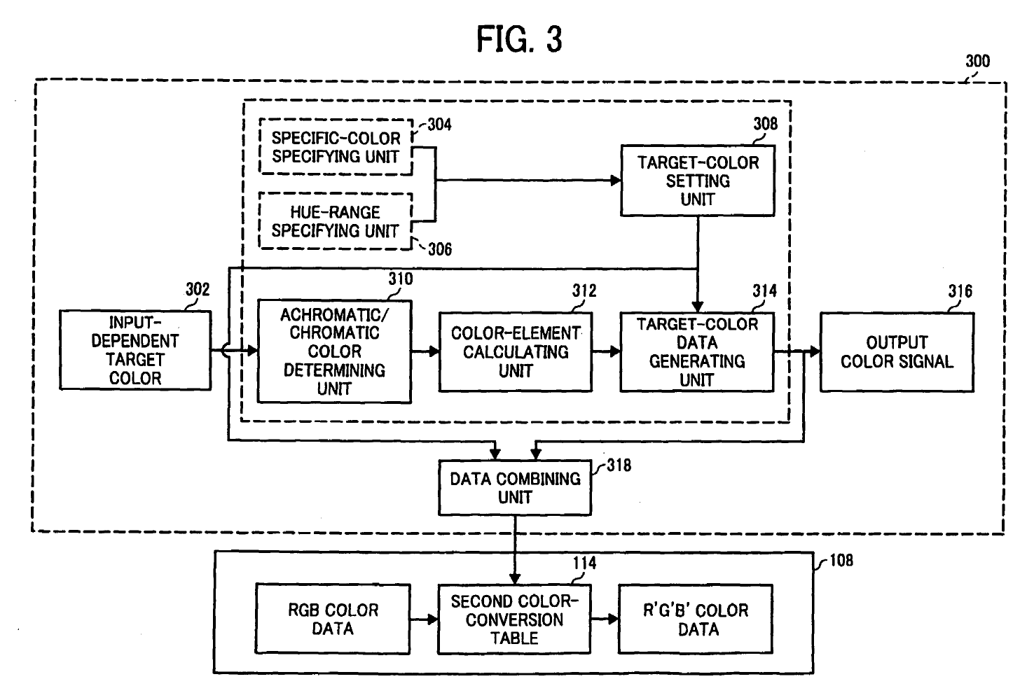

FIG. 3 is a functional block diagram of a second-color-conversion-table generating unit 300 used by the image processing apparatus 100 according to the present embodiment. The second-color-conversion-table generating unit 300 shown in FIG. 3 is implemented as a module different from the color-conversion processing unit 110 of the printer driver 108. In an exemplary embodiment according to the present invention, however, the second-color-conversion-table generating unit 300 can also be realized as a functional module of the printer driver 108 or a functional module of the color-conversion processing unit 110, considering the fact that specific-color conversion by the user is to be performed on demand. If the second-color-conversion-table generating unit 300 is realized as a module different from the printer driver 108, the printer driver 108 stores the second color-conversion table 114 generated by the second-color-conversion-table generating unit 300, for example, in an HDD, a ROM, an EEPROM, or an EPROM so that the second color-conversion table 114 can be used for processing.

The second-color-conversion-table generating unit 300 includes a specific-color specifying unit 304 constructed, for example, as a graphical user interface (GUI) and a hue-range specifying unit 306 that is also provided as a GUI. The specific-color specifying unit 304 and the hue-range specifying unit 306 each function as a setting unit that displays a color palette, for example, in a display window and receives a specific color and a hue range from the user to set the specific color and hue range. A target-color setting unit 308 functions as a setting unit that receives color data into which the user wants to convert the specific color and the hue range and sets the color data. It is also constructed as, for example, a GUI. The target-color setting unit 308 also constitutes setting units that set an input-dependent target color on RGB display in the image processing apparatus 100. The term “input-dependent target color” means a target-color setting value based on the RGB calorimetric system that is specified by the printer driver 108 via, for example, a color palette.

The specific color, the hue range, and the target color obtained by the specific-color specifying unit 304, the hue-range specifying unit 306, and the target-color setting unit 308 are used to generate an output-device-dependent target color in a target-color data generating unit 314. The term “output-device-dependent target color” means color data whose color can be reproduced by a printer and that is most approximate to the input-dependent target color in the CIE1976L*a*b* uniform color space. The target-color data generating unit 314 uses the RGB values of the specific color and the hue range to set the output-device-dependent target color as the most approximate color data in the color reproduction space of the printer. Furthermore, after setting the output-device-dependent target color, the target-color data generating unit 314 generates a constant-hue line (described later) and generates a target-color gradation level for the hue of the target color along the constant-hue line. The target-color data generating unit 314 can generate data values as values, for example, in the CIE1976L*a*b* uniform color space. Although a data value can be generated based on another colorimetric system, it is preferable that a uniform color space be used in order to efficiently perform input-dependent to output-device-dependent color conversion. It is needless to say that the CIE1976L*u*v* uniform color space can also be used as the uniform color space.

The second-color-conversion-table generating unit 300 obtains an input-dependent target color 302 set by the target-color setting unit 308 and determines whether the relevant RGB color data is a chromatic color or an achromatic color in an achromatic/chromatic color determining unit 310. Thereafter, in response to the determination as to whether the RGB color data is a chromatic color or an achromatic color, a color-element calculating unit 312 calculates color elements such as the luminance, the color saturation, and the hue using different algorithms for each of the luminance, the color saturation, and the hue so that the color elements can be used for processing by the target-color data generating unit 314. The output result of the color-element calculating unit 312 is sent to the target-color data generating unit 314, where R′G′B′ values are calculated from the L*a*b* values of each color element and are used as an output color signal 316 for the subsequent processing.

The second-color-conversion-table generating unit 300 sends to a data combining unit 318 the RGB color data corresponding to the specific color and the hue range and the R′G′B′ color data that provides the output-device-dependent target color through color conversion based on the first color-conversion table 112. The data combining unit 318 generates the second color-conversion table 114 as a lookup table registering the RGB-R′G′B′ relationship and registers the lookup table, for example, in a RAM to allow the printer driver 108 to use the lookup table for RGB-R′G′B′ color conversion.

As another embodiment, the second color-conversion table 114 can be constructed as a table for conversion from the RGB to CMY system, as with the first color-conversion table 112. For the another embodiment, the second color-conversion table 114 is provided in the form of firmware, that is, prestored in a non-volatile memory device such as an EROPM, an EEPROM, or a non-volatile random access memory (NVRAM). Although the specific color and the hue range can be subjected to color conversion also in the another embodiment, the present embodiment in which the second color-conversion table 114 is implemented as a lookup table for RGB to R′G′B′ conversion is more preferable in the following points: that is, increase in memory consumption in the color conversion from RGB to CMY that provides the output-dependent system because the second color-conversion table 114 is needed in addition to the first color-conversion table 112; effective use of the first color-conversion table 112; and flexibility in outputting the specific color or the hue range from the user on demand in the target color.

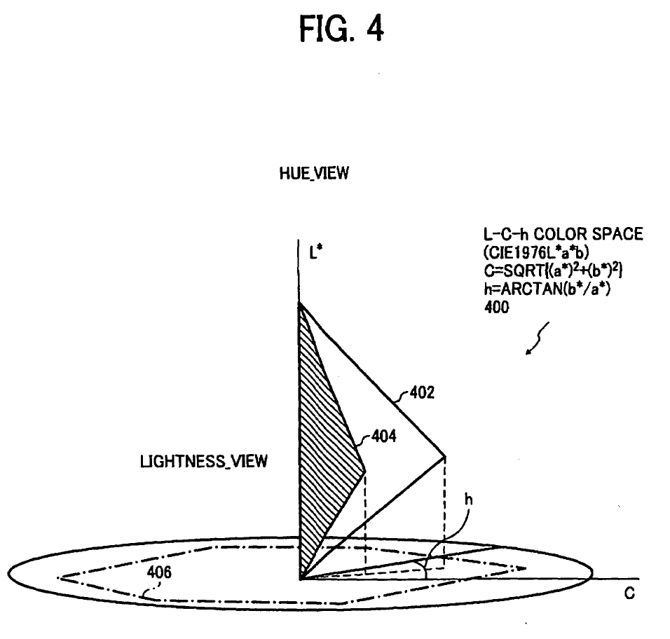

FIG. 4 is a schematic diagram for explaining specific-color conversion processing in which the second color-conversion table 114 is used based on the CIE1976L*a*b* colorimetric system that is interchangeable with the RGB and CMY systems. Referring to FIG. 4, a psychometric color quantity is defined in a CIE1976L*a*b* colorimetric system 400 by the use of C (chroma) and L* (luminance level). C (chroma) is given by C=sqrt{(a*)²+(b*)²}, indicating color saturation, whereas L* corresponds to a luminance level. On the hue plane, h (Hue) is given by h=arctan(b*/a*). The output-device-dependent color-reproducing range corresponds to a color-reproducing range 406, which can be obtained by projecting the printable color data in the L*a*b* calorimetric system onto the C plane.

The value of L* in a case where particular color saturation is provided is also determined depending on the hue. With a luminance level of zero or with the maximum luminance level, the value of C is zero (C=0), which ideally means an achromatic color (loss of color saturation). In FIG. 4, a triangle 402 and a triangle 404 have vertices of the same hue angle but different color saturations. In the L*a*b* colorimetric system shown in FIG. 4, changing the gradation level to reproduce a particular hue, that is, a target color, corresponds to providing the L*a*b* values of points representing the vertices of the triangles 402 and 404 while keeping the hue angle h constant.

If the second color-conversion table 114 is constructed to include values of the L*a*b* calorimetric system that are referred to when the RGB color data of the specific color or the hue range is converted into a target color based on the CMY system, not only is association of RGB→L*a*b*←CMY normally needed but also interpolation for this association is required. Furthermore, although the second color-conversion table 114 can be built with the same structure as that of the first color-conversion table 112, which is already generated, the data registered in the first color-conversion table 112 is not effectively used if this approach is adopted.

For this reason, in the present embodiment, the second color-conversion table 114 is formed by calculating R′G′B′ values as a set of a target color or a color-reproducible sampling point closest to the target color and RGB values that provide a gradation color with the hue angle given at the sampling point from the output-device-dependent target color, and then by associating the calculated R′G′B′ with the set of RGB values that provide the specific color or the hue range. When the user specifies specific-color conversion processing, the image processing apparatus 100 examines RGB values included in the image produced after raster conversion of the document 104 to be printed and then determines whether the RGB values are registered in the second color-conversion table 114. In this case, color conversion can be performed at high speed because searching of the second color-conversion table 114 can be performed merely by directly comparing the RGB values included in the raster image with the RGB values of the specific color or determining whether the RGB values included in the raster image are within a set of RGB values of the specific color. In addition, specific-color conversion processing can be performed without having to dramatically change the existing color conversion processing. Because the second color-conversion table 114 does not need to manage data in the entire color-reproducing range, it can be generated in blocks each representing a representative point. However, it can also be generated to include data in the entire color-reproducing range.

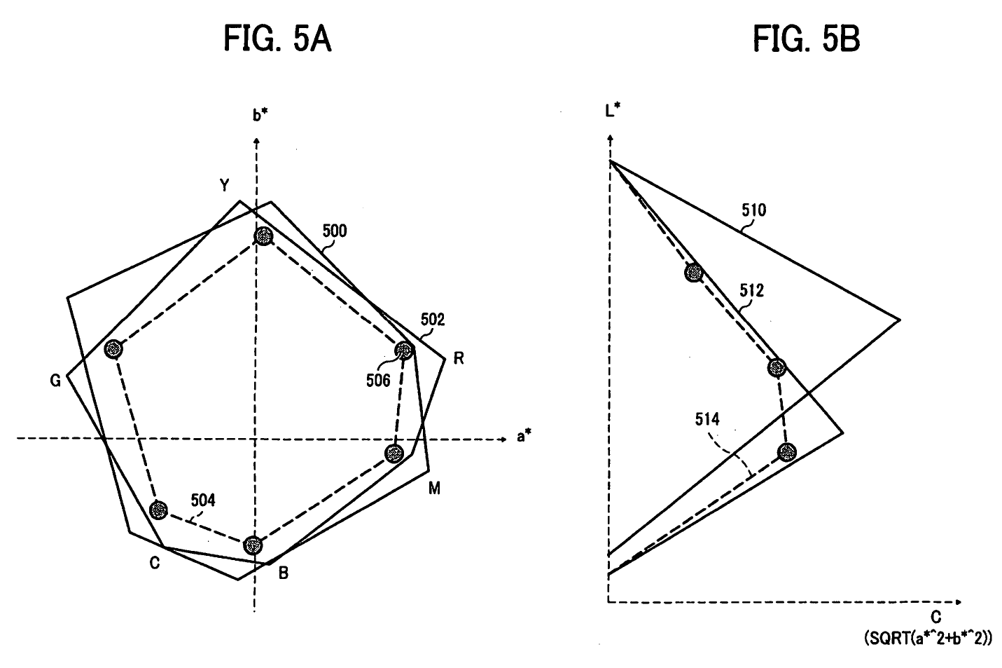

FIGS. 5A and 5B are graphs for explaining color conversion processing according to the present embodiment based on the L*a*b* calorimetric system. FIG. 5A is a graph where color reproduction is projected onto the hue plane (corresponding to the Hue_view direction in FIG. 4). FIG. 5B is a graph illustrating plots generated by projecting color reproduction in the Lightness_view direction of FIG. 4. Referring to FIG. 5A, a line 500 indicates a range of input-dependent target colors specified by the user through, for example, a print wizard provided by the printer driver, and the color-reproducing range indicated by the line 500 corresponds to an input-dependent range specified by the user on the desktop, for example, a range specified in compliance with the NTSC standards. On the other hand, a line 502 indicates a color reproduction area where output-device-dependent colors given by color material, such as toner and ink, are reproducible when target colors are reproduced by the printer 120.

From a practical viewpoint, the printer 120 performs color reproduction through the subtractive color mixing process and furthermore based on the CMY system for the purposes of, for example, black reproducibility and reducing the amount of color material. If the K component is included, color reproducibility is confined to a range slightly smaller than the color-reproducing range of CMY given by the color material. Therefore, to reproduce target colors, the color-reproducing range defined by a line 504 is adopted, and each of the target colors is given as a point indicated by a circle on the line 504. On the other hand, when viewed as a projection onto the luminance-saturation plane, the range of the input-dependent target colors specified by the user on the desktop is indicated by a line 510. Although target colors reproduced by the actual printer 120 can be reproduced within the range of a color-reproducing range 512, the target colors, depending on the output device, actually reproduced by the printer (hereinafter, referred to as the output-device-dependent target colors) are indicated by points on a line 514 depending on, for example, the characteristics of the color material, gradation performance, and resolution.

In the present embodiment, color reproduction of the output-device-dependent target color is performed with respect to the hue and the color saturation, and the point at which the color difference from the input-dependent target color exhibits the smallest value based on the L*a*b* calorimetric system in the color-reproducible range is set as the output-device-dependent target color. For example, in FIG. 5A, the point of the output-device-dependent target color for reproducing the input-dependent target color is given at a point 506. Once the point of the output-device-dependent target color is determined, a line is defined between that point and the origin (a*=0, b*=0) on the hue plane. With this line serving as a constant-hue line, the a* and b* values of gradation color are determined and the L* value at that time is determined to obtain the sequence of L*a*b* values corresponding to the gradation color level. Thereafter, the R′G′B′ sequence that gives the L*a*b* sequence is calculated.

The specific color or the hue range is given as input-dependent RGB color data or a set of input-dependent RGB color data based on the user specification given via a print dialog. Therefore, by associating the RGB color data range specified by the user with its gradation color, the RGB-R′G′B′ second color-conversion table 114 that associates RGB with R′G′B′ values providing the output-device-dependent target color is generated.

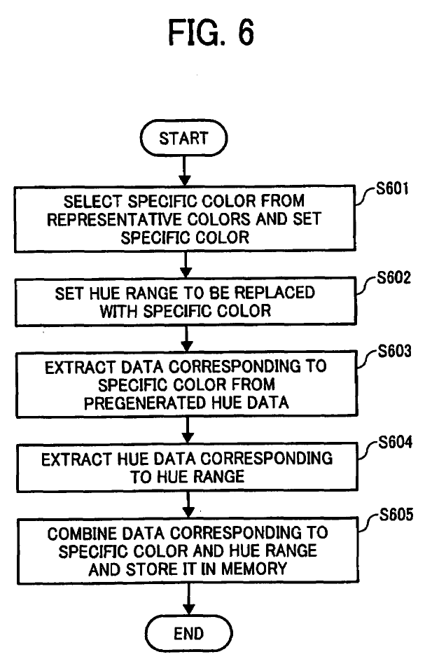

FIG. 6 is a flowchart of processing (extraction of RGB data) for generating the second color-conversion table 114. At Step S601, the user selects a specific color from among representative colors displayed in a print dialog to set the selected specific color. At Step S602, a hue range that is replaced with the specific color is set. When a specific color and a hue range are to be set, a color palette displaying hues for each setting is provided so that the specific color and the hue range can be set easily. One specific color can be specified or more than one specific color can be specified.

At Step S603, RGB data corresponding to the specific color is extracted from the hue data where the pre-generated existing color-reproducing range is registered. At Step S604, RGB data corresponding to the hue range is extracted. Thereafter, at Step S605, the RGB data corresponding to the specific color and the hue range are combined and are then stored in a memory such as a buffer memory. Then, the processing ends.

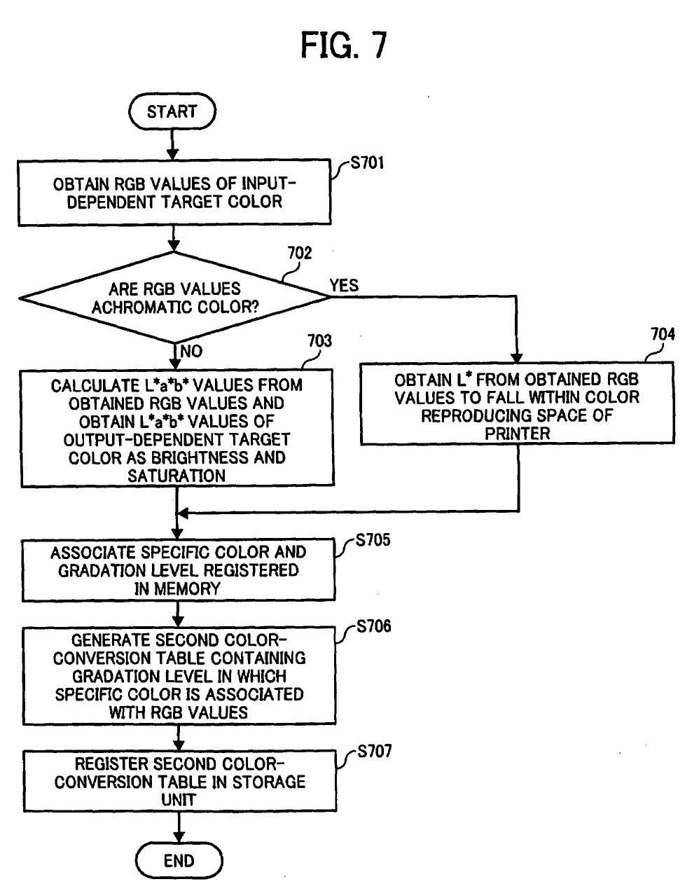

FIG. 7 is a flowchart of processing for registering the second color-conversion table 114 that associates calculated R′G′B′ values with RGB values of a specific color or a hue range. At Step S701, RGB color data of the input-dependent target color is obtained. At Step S702, whether or not the obtained RGB values represent an achromatic color is determined based on whether or not R=G=B based on the criterion in the HSV color space. If it is determined that the obtained RGB values are not an achromatic color (NO at Step S702), the system control proceeds to Step S703, where L′*a′*b′* values are calculated from the obtained RGB values, and the point at which the color difference is the smallest is set as the output-dependent target color. On the other hand, if R=G=B (YES at Step S702), that is, it is determined that the RGB values are an achromatic color, then the system control proceeds to Step S704, where the output-dependent target color can be obtained by calculating only L*.

At Step S705, a constant-hue line connecting the point having the calculated L′*a′*b′* values to the origin of the hue circle is calculated. The gradation point of color saturation a* and b* that exists on the constant-hue line and corresponds to the gradation to be set is obtained to determine the corresponding L* and to set it as gradation color level data.

At Step S706, a set of R′G′B′ values is calculated and obtained from the L′*a′*b′* values of the output-device-dependent target color and gradation color, and an RGB-R′G′B′ lookup table is generated for each gradation level. At Step S707, these lookup tables are registered in a recording unit such as a RAM or an EPROM, and the processing ends. Subsequently, after the second color-conversion table 114 has been generated, the processing shown in FIG. 7 ends. The second color-conversion table 114 can be registered in a non-volatile memory device such as an HDD according to a command from the user. Alternatively, the second color-conversion table 114 can be discarded after the job has ended.

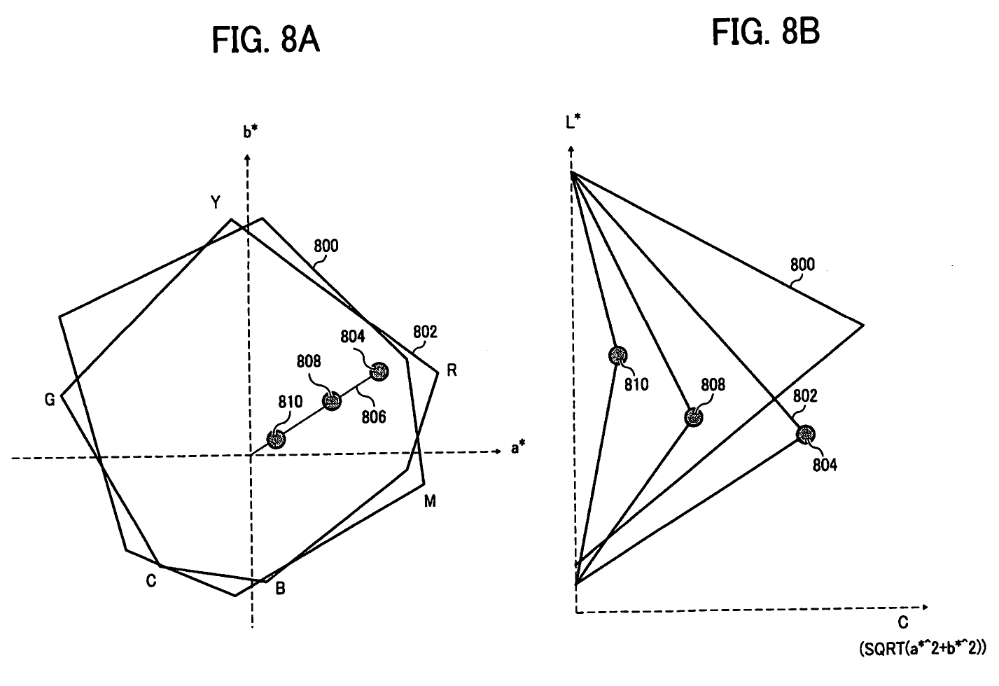

FIGS. 8A and 8B are graphs depicting the processing at Step S704 described with reference to FIG. 7. FIG. 8A is a graph depicting projection onto the hue plane, whereas FIG. 8B is a graph depicting projection onto the luminance-saturation plane. Referring to FIG. 8A, for the color-reproducing range, a line 800 indicates the input-dependent target color range, and a line 802 indicates the output-device-dependent target color range. Within the output-device-dependent target color range, a point 804 is a point of the output-device-dependent target color. Furthermore, points 808 and 810 indicate points that provide gradation data along a constant-hue line 806, i.e., obtained points equal in number to the number of gradation levels to be set, for example, the number corresponding to an 8-bit depth. According to the present embodiment, even if specific-color conversion processing is performed, the gradation level can be obtained while the hue is maintained by setting the output-device-dependent target color and obtaining gradation data along the constant-hue line, thereby performing higher-definition color reproduction and image output.

FIG. 8B is a graph depicting luminance-saturation changes when each data point is projected onto the luminance-saturation plane. If inking is performed, for example, with a highlight pen or a chromatic-color ballpoint pen, no changes in the small-value direction occur on the luminance axis L*. Therefore, if there are points having the same a* and b*, the point having larger L* is selected as a data point. If it is determined that the RGB values are an achromatic color, gradation reproduction of the achromatic color can also be performed by obtaining the same number of items of gradation data as the number of gradation levels on the L* axis.

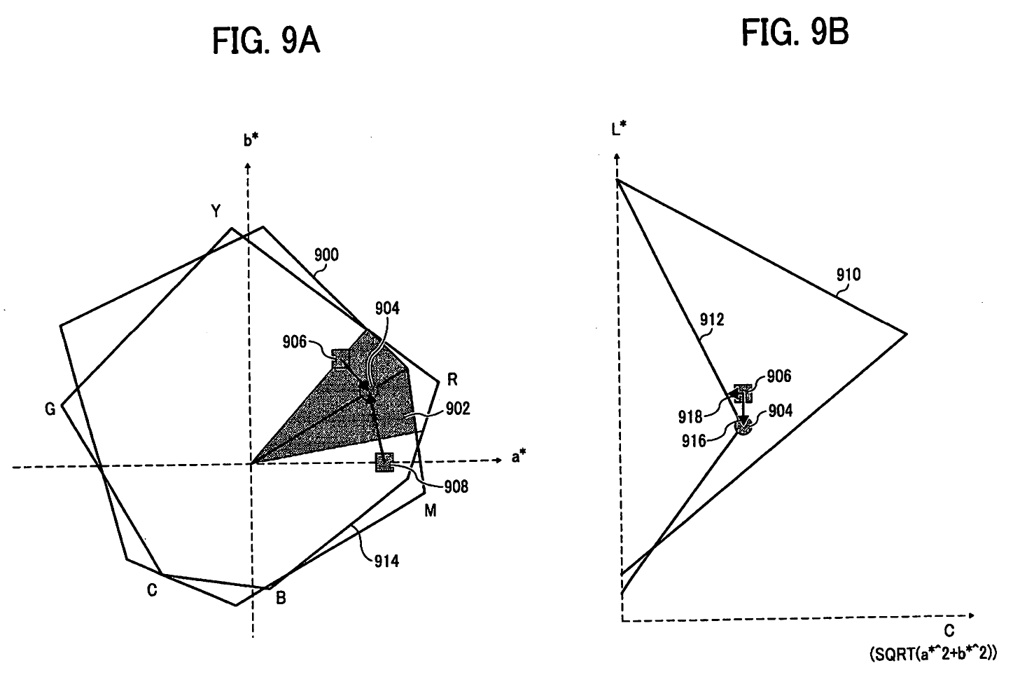

FIGS. 9A and 9B are graphs depicting the relationship among the RGB data, the hue range, and specific-color conversion processing of an image. FIG. 9A is a graph depicting projection onto the hue plane. FIG. 9B is a graph depicting projection onto the luminance-saturation plane. Referring to FIG. 9A, a hue range 902 specified by the user is superimposed over a range 900 indicating the input-dependent target color. The range indicated by a line 914 that is an output-device-dependent target color range is also subjected to the same processing. As shown in FIG. 9A, a point 906 is an RGB point of the image corresponding to the boundary of the hue range, and in this case print data is produced by changing the color on the constant-hue line. In the present embodiment shown in FIG. 9A, R′G′B′ values are obtained by referring to the second color-conversion table 114 based on the RGB values obtained from the image, subjected to color conversion at a point 904 on the constant-hue line by using the first color-conversion table 112, and finally output as print data.

On the other hand, because a point 908 is not in the hue range specified by the user, print data is generated with the hue/color saturation of the point 908 maintained, by using only the first color-conversion table 112 (without referring to the second color-conversion table 114). When the point is converted from the point 906 to the point 904, constant saturation (C=C′) conversion can be used, or alternatively, the data point on the constant-hue line can be obtained through constant luminance (L*=L′*) conversion. Instead of constant-saturation conversion and constant-luminance conversion, the point 904 that provides the minimum color difference between points (ΔL*a*b*=min, where ΔL*a*b* is the norm between the point 908 and the point 904 in the CIE1976L*a*b* uniform color space) can be selected for conversion from the point 906 to the point 904. In addition, in order to improve the processing speed, a minute value ε is set for the color difference so that the first point 904 that gives ΔL*a*b*<ε can be selected. The selection of constant-luminance conversion, constant-saturation conversion, and minimum color-difference conversion can be set as appropriate by setting the RGB-R′G′B′ association when the second color-conversion table 114 is to be generated. FIG. 9B is a graph depicting a line 916 corresponding to constant-saturation conversion and a line 918 corresponding to constant-luminance conversion with respect to the point 906. Although the present embodiment shown in FIGS. 9A and 9B is described assuming that constant-saturation conversion (C=C′) is used, constant-saturation conversion is more preferable in order to highlight the inking more noticeably.

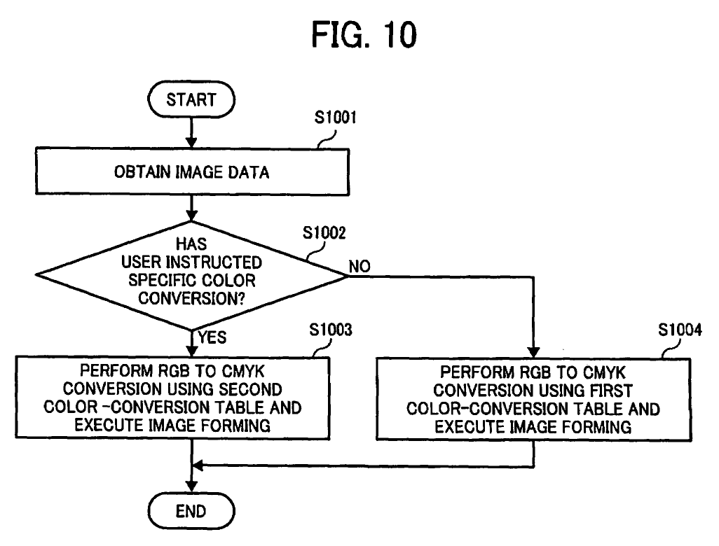

FIG. 10 is a flowchart illustrating an image processing method performed by the image processing apparatus 100 according to the present embodiment. The image processing method shown in FIG. 10 can be implemented not only as a printer driver of the image processing apparatus 100 but also as a printer application of a multi-function peripheral. At Step S1001, image data is obtained. The obtaining of image data at Step S1001 includes (1) acquisition of image data from a scanner and (2) reading of a raster image or compressed image data (e.g., GIF, BMP, TIFF, portable network graphics (PNG), JPEG, JPEG2000) stored, for example, in an HDD.

At Step S1002, it is determined whether the user has instructed specific-color conversion processing through a print dialog. If no specific-color conversion processing is specified (NO at Step S1002), the system control proceeds to Step S1004. In this case, color conversion processing from RGB to CMYK is performed using only the first color-conversion table 112, print data including an image is generated, the print data is transmitted to the printer 120, and the processing ends. On the other hand, if the user has instructed specific-color conversion processing (YES at Step S1002), then the system control proceeds to Step S1003, where color conversion processing from RGB to CMY is performed using the second color-conversion table 114, print data including an image that has been subjected to color conversion into CMYK using the first color-conversion table 112 is generated, the print data is transmitted to the printer 120, and the processing ends.

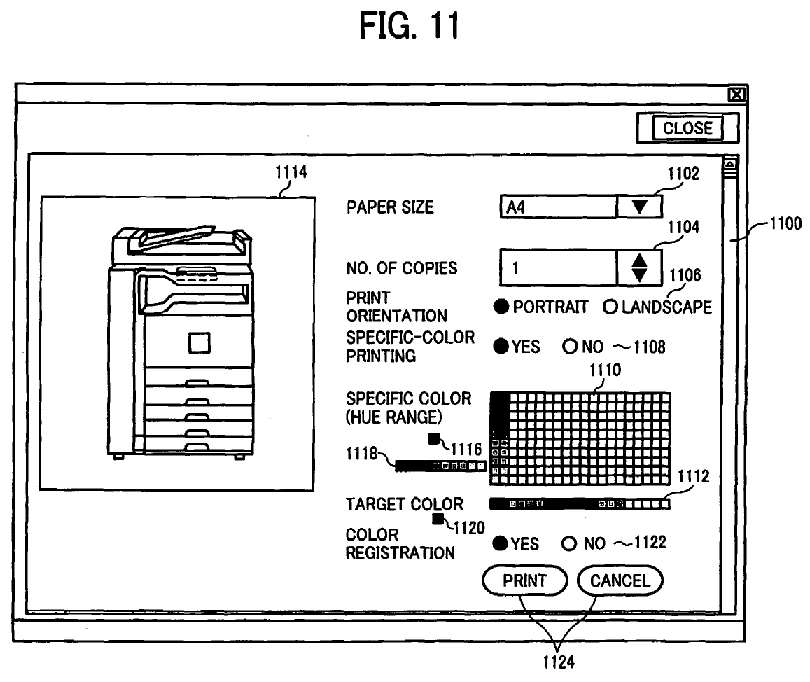

FIG. 11 is a schematic diagram of a print dialog 1100 displayed for the user by the image processing apparatus 100 according to the present embodiment. Although the print dialog 1100 shown in FIG. 11 will be described assuming that it is implemented in the form of a printer driver of, for example, a personal computer that uses an MFP as a network printer, a similar display interface can be constructed to perform specific-color conversion processing also when the image processing apparatus 100 is implemented as an MFP. The print dialog 1100 shown in FIG. 11 is provided with a display frame 1114 that displays error information, such as paper out, of the image processing apparatus 100 using, for example, the simple network management protocol (SNMP) so that troubleshooting appropriate for the state of the image processing apparatus 100 can be performed.

A pull-down menu 1102 that specifies a paper size, scroll buttons 1104 that set the number of copies, radio buttons 1106 that specify a printing orientation, and so forth are displayed in the print dialog 1100. The user performs print setting by the use of the pull-down menu 1102, the scroll buttons 1104, and the radio buttons 1106.

The print dialog 1100 shown in FIG. 11 includes other GUIs through which specific color specification processing provided in the present embodiment is instructed. These GUIs are a specific-color specifying color palette 1110 and a target-color specifying color palette 1112. In the print dialog 1100 shown in FIG. 11, a specific color is specified by checking a color box with which the user can specify the specific color. A specific color 1116 that has been specified is displayed at an easily identifiable location in the print dialog 1100.

In addition, when the user is to specify a hue range, an interface such as area selection or color box selection can be used to specify an area in the color palette 1110 as a hue range. The selected hue range is displayed as a hue range 1118 at an appropriate location in the print dialog 1100. A target color can also be selected in a similar manner by using the target-color specifying color palette 1112. The present embodiment shown in FIG. 11 illustrates specific-color conversion of the range corresponding to the specific color 1116 and the hue range 1118 (fluorescent pink) into, for example, a target color “magenta” together with its gradation.

After completing setting of specific-color conversion, the user clicks a print control button 1124 to instruct the image processing apparatus 100 to execute or cancel printing. The specific color, the target color, and the hue range input by the user with the use of appropriate color-specifying units can be registered or discarded (when a predetermined job ends) through selection of a radio button 1122 that specifies whether or not to perform color registration. If a particular print job is, for example, a one-off job, performing color registration causes memory resources, such as a RAM, of the image processing apparatus 100 to be consumed. Therefore, if, for example, there is a risk of causing a problem in processing of other applications, the user can specify that the generated second color-conversion table be discarded when the job is completed. However, when the same specific-color conversion is to be performed, discarding the second color-conversion table causes the efficiency to decrease because the second color-conversion table is generated on the fly.

On the other hand, if the user selects the radio button “Yes” for color registration as shown in FIG. 11, then the image processing apparatus 100 stores the selected specific color, hue range, target color, and the second color-conversion table 114 in a non-volatile memory device, such as an HDD, an EPROM, or an EEPROM. The stored data used for color conversion is read out as default color conversion settings the next time the print dialog 1100 is started up. In other words, the stored data is automatically reproduced as preset data in the print dialog 1100. It is suitable for industrial use rather than personal use that the print dialog 1100 is started up with preset data. In other words, this is preferable in a case where similar processing is repeated.

As a modification of the present embodiment, it is conceivable that a specific color is set in an invalid range or the specified specific color is unreproducible due to limitations of the specifications and resources of the image processing apparatus 100. In this case, the specified specific color can be converted into an achromatic color for specific-color conversion processing. Alternatively, specification in such an invalid range can be ignored, displaying a message such as “Color cannot be output” in a print dialog.

As described above, the image processing apparatus 100 according to the present embodiment can perform specific-color conversion processing while still reducing the consumption of memory resources thereof by efficiently using the first color-conversion table for normal color conversion, in addition to the second color-conversion table. Furthermore, because specific-color conversion processing reproduces gradation color while maintaining the hue of the target color along the constant-hue line, the specific-color conversion processing prevents only regions of the specific color from being printed as a binary image. That is, specific-color conversion can be performed while maintaining image reproducibility.

In addition, even for an image that has undergone inking with, for example, a highlight pen or another hue, conversion into the target color, such as magenta or another more recognizable hue, is possible while maintaining the gradation reproducibility. Therefore, specific-color conversion and enhancement in recognizability of inking can be achieved while retaining the gradation reproducibility. Furthermore, even for specific-color conversion, it is not necessary to implement a different processing program (although the color-conversion table to be used is different). The specific-color conversion processing can be performed without having to extensively modify the processing program, that is, merely by adding an object that processes an event supported by the print dialog 1100 shown in FIG. 11.

The above functions of the present embodiment can be achieved with a device-executable program described in a legacy programming language, such as assembler, or an object-oriented programming language, such as C++ or Java®. Such a computer program can be distributed prestored on a device-readable recording medium, such as a hard disk drive, a CD-ROM, an MO, a flexible disk, an EEPROM, or an EPROM. Alternatively, such a computer program can be transmitted via a network in a format that can be read by other devices.

The present invention is not limited to the embodiments that have been described so far. The embodiments can be subjected to addition, modification, or deletion within a range conceivable to those skilled in the art. Other embodiments can also be covered by the range of the present invention as long as those embodiments achieve the same operation and afford the same advantages according to the present invention.

The present invention efficiently performs specific-color conversion for converting a specific color and a hue range specified by a user into a particular target color, provided that a document contains a plurality of hues, while still maintaining the gradation performance of the target color as far as possible. To reproduce the target color, the image processing apparatus includes a color converting unit that registers RGB color data in compliance with, for example, the NTSC standards in association with other color data.

If a document contains a specific color and a specified hue range, the color converting unit performs color conversion processing to generate color data for reproducing the RGB color data of the specific color and the hue range according to the CMYK system, which is a calorimetric system depending on the output device, and sets the generated color data as color data for generating raster data used by the printer.

The raster data that has been subjected to color conversion processing is sent to the printer as print data, thus providing printed matter in which the specific color and the specified color range are replaced with the target color.

According to one aspect of the present invention, because it is possible to perform specific-color conversion by efficiently using the color-conversion table adopted for normal processing (i.e., when specific-color conversion is not performed), while maintaining gradation, high-definition specific-color conversion processing can be achieved merely by adding a correction routine for input RGB data without implementing a plurality of color conversion programs.

According to another aspect of the present invention, it is possible to reduce memory consumption of the image processing apparatus and allow the user to flexibly specify specific-color conversion processing.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus that prints a first color in an image in a second color in a printout, the image processing apparatus comprising:
a first-color setting unit that specifies the first color in a red-green-blue calorimetric system;
a second-color setting unit that sets the second color;
a color determining unit that determines whether the first color is a chromatic color or an achromatic color; and
a color converting unit that, when the color determining unit determines that the first color is a chromatic color, performs color conversion processing of converting the first color into a color that is reproduced with a gradation level having a hue same as the second color and a color saturation lower than the second color.

2. The image processing apparatus according to claim 1, wherein the color converting unit performs different color conversion processing depending on whether the first color is a chromatic color or an achromatic color.

3. The image processing apparatus according to claim 1, wherein the color converting unit performs the color conversion processing based on the gradation level of the first color.

4. The image processing apparatus according to claim 1, further comprising a hue-range setting unit that specifies a hue range of the first color, wherein
the color converting unit converts color data of the first color and the hue range into the hue of the second color reproduced with the gradation level.

5. An image processing method executed by an image processing apparatus that prints a first color in an image in a second color in a printout, the image processing method comprising:
receiving specification of the first color in a red-green-blue calorimetric system;
receiving setting of the second color;
determining whether the first color is a chromatic color or an achromatic color;
first converting including, when it is determined at the determining that the first color is a chromatic color, converting the first color into a color that is reproduced with a gradation level having a hue same as the second color and a color saturation lower than the second color; and
second converting including, when it is determined at the determining that the first color is an achromatic color, converting a luminance level of the achromatic color to reproduce the achromatic color with the gradation level.

6. The image processing method according to claim 5, further comprising:
specifying a hue range of the first color; and
third converting including converting color data of the first color and the hue range into the hue of the second color reproduced with the gradation level.

7. The image processing method according to claim 6, wherein the third converting is performed by any one of a constant-saturation conversion, a constant-luminance conversion, and a minimum color-difference conversion.

8. A computer program product that includes a computer-readable recording medium that stores therein a computer program including computer program codes that when executed cause an image forming apparatus to execute:
receiving specification of the first color in a red-green-blue colorimetric system;
receiving setting of the second color;
determining whether the first color is a chromatic color or an achromatic color;
first converting including, when it is determined at the determining that the first color is a chromatic color, converting the first color into a color that is reproduced with a gradation level having a hue same as the second color and a color saturation lower than the second color; and
second converting including, when it is determined at the determining that the first color is an achromatic color, converting a luminance level of the achromatic color to reproduce the achromatic color with the gradation level.

9. The computer program product according to claim 8, wherein the computer program is a printer driver.

10. The computer program product according to claim 8, wherein the computer program is a printer application in the image forming apparatus.
